(19) United States
(12) Patent Application Publication
(10) Pub. No.: US 2005/0082845 A1
(43) Pub. Date: Apr. 21, 2005

(54) Tamper evident seal

(76) Inventors: Gregory C. Freimuth, St. Charles, IL (US); William J. Kobemus, St. Charles, IL (US)

Correspondence Address: JONATHAN D. FEUCHTWANG, 150 NORTH WACKER DRIVE, SUITE 1200, CHICAGO, IL, 60606, US

(21) Appl. No.: 10/688,609

(22) Filed: Oct. 17, 2003

(51) Int. Cl. E05C 17/32

(52) U.S. Cl. 292/263

(57) ABSTRACT

A tamper-evident seal including a main body, a flexible loop attached at one end to the main body and a receptacle. The receptacle is configured to at least partially receive a free end of the flexible loop. The receptacle is provided with non-releasable engagement means for retaining the free end within said receptacle, wherein the flexible loop is configured to fail before the non-releasable engagement means releases the free end.

### FIELD OF THE INVENTION

The present invention generally relates to tamper evident seals. More particularly, the present invention relates to a tamper evident seal which may be removed by hand without an undue amount of force and without the use of scissors or other tools.

### BACKGROUND OF THE INVENTION

Recent security concerns have resulted in a variety of security measures aimed at increasing the safety of the traveling public. For example, airlines are now required to screen all of the checked baggage.

Conventional metal locks are now prohibited from all checked baggage because they interfere with the screening of baggage. Consequently, some passengers have opted to secure their luggage using non-metallic seals such as a conventional wire tie. Unfortunately, conventional non-metallic seals are problematic as their removal requires the use of tools such as scissors or the like. Notably, most airlines now prohibit passengers from bringing sharp objects such as scissors or nail clippers in their carry-on baggage or on their person. As a result, passengers using conventional non-metallic seals are undesirably hampered from access their luggage upon reaching their destination.

Accordingly, what is needed is a non-metallic fastener which may be opened without the need for tools such as scissors or the like which will indicate whether the contents have been accessed.

### SUMMARY OF THE INVENTION

Disclosed is a tamper-evident seal including a main body, a flexible loop having a free end and a fixed end, the fixed end being attached to the main body. The main body is provided with a receptacle configured to at least partially receive the free end of the flexible loop, and non-releasable engagement means for retaining the free end within the receptacle. The flexible loop is configured to fail before the non-releasable engagement means releases the free end.

According to one aspect of the invention the flexible loop is composed of nylon.

According to another aspect of the invention the body and the non-releasable engagement means are composed of a non-metallic material.

According to another aspect of the invention the flexible loop is configured to fail when subjected to a tensile force of between 5 and 18 lbs.

According to another aspect of the invention the flexible loop includes a region of diminished thickness configure to fail before the non-releasable engagement means releases the free end.

According to another aspect of the invention the flexible loop includes a notched portion configure to fail before the non-releasable engagement means releases the free end.

According to another aspect of the invention the non-releasable engagement means includes a tapered head provided on the free end, the tapered head having a shoulder; and at least two flanges provided on the receptacle, the flanges provided in a spaced relationship to receive and retain the tapered head therebetween.

### BRIEF DESCRIPTION OF THE DRAWINGS

Preferred embodiments of the present invention are described herein with reference to the drawings wherein:

FIG. 1 is a front view of the tamper evident seal of the present invention;

FIG. 2 shows the tamper evident seal according to FIG. 1 in a closed or latched position;

FIG. 3A shows the tamper evident seal of FIG. 1 with a thinned region; and

FIG. 3B shows the tamper evident seal of FIG. 1 with a notched region.

### DETAILED DESCRIPTION OF THE INVENTION

Disclosed is a non-metallic tamper evident seal for use in securing a zipper or the like. The tamper evident seal of the present invention is constructed in such a manner as to fail when subjected to a force within the range of 5-18 lbs. Notably, a specific goal of the present invention is to provide a seal which a person may break with his/her fingers without the need for any tools. However, the seal must be of a sufficiently rugged construction as to resist incidental stress during handling.

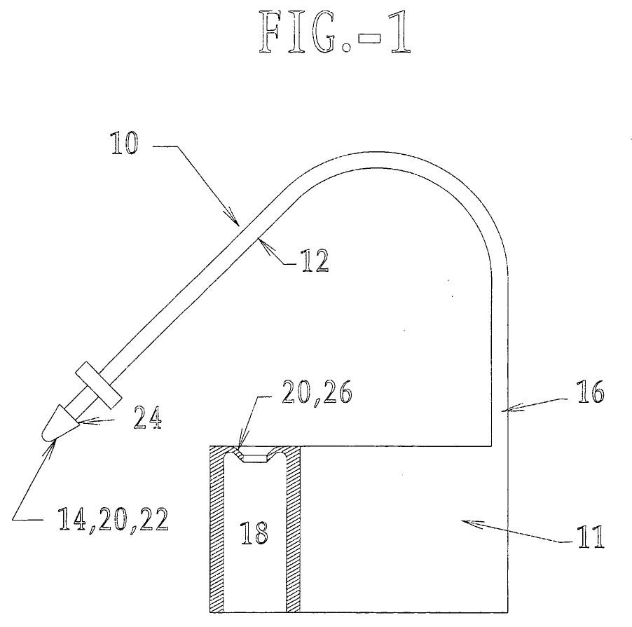

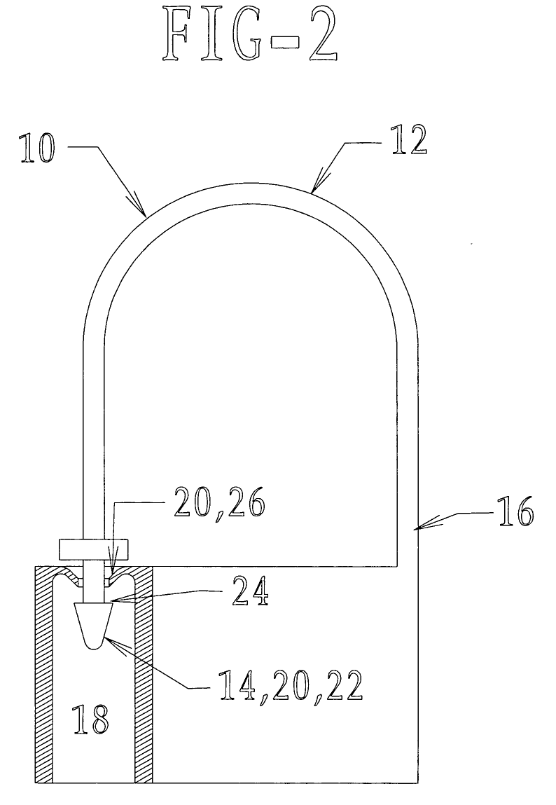

FIGS. 1 and 2 depict a first embodiment of the tamper evident seal 10 of the present invention.

The seal 10 includes a main body 11 and a flexible loop 12 having a free end 14 and a fixed end 16 fastened the main body 10.

The main body 11 further includes a receptacle 18 adapted to receive the free end of the flexible loop 12. The free end 14 and receptacle 18 are provided with a 1-way engagement system 20.

The 1-way engagement system 20 is configured to secure the free end 14 within the receptacle 18 such that the free end 14 may not be removed without breaking the seal 10.

As will be appreciated by one of ordinary skill in the art, there are a variety of different ways to ensure that the seal 10 will fail when subjected to a given force.

In the embodiment depicted in FIG. 1, the flexible loop 12 is formed of a material such as nylon having a relatively low tensile strength such that the flexible loop 12 will break when subjected to a load of between 5 and 18 lbs. In contrast, a conventional nylon wire tie will not fail unless subjected to a tensile stress in excess of 45 lbs.

It should be appreciated that the flexible loop 12 and/or the seal 10 of the present invention may be formed of other non-metallic materials selected to fail when subjected to a force of between 5-18 lbs. Again, the flexible loop 18 of the present invention should be sufficiently robust as to resist inadvertent stresses which may be applied to the seal 10 during handling of the luggage, but should still break at a sufficiently low load that a person may break the seal by hand and without the need for special tools such as scissors or the like.

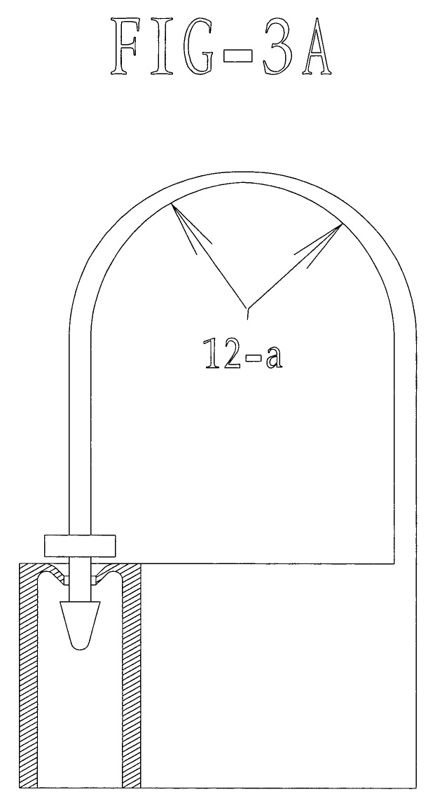

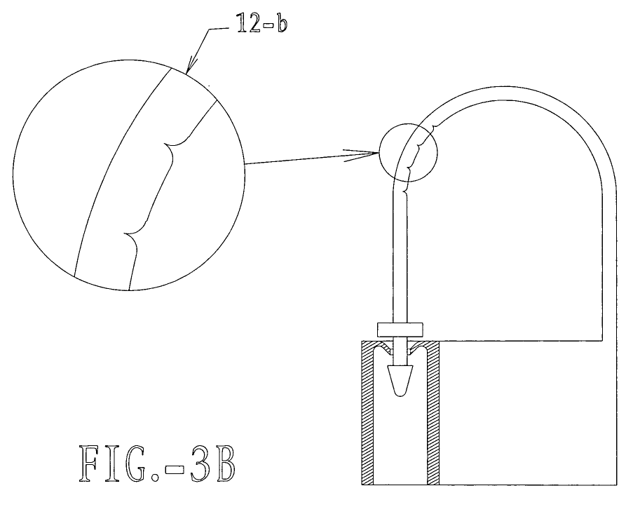

As shown in FIG. 3A, the flexible loop 12 may be provided with an optional thinned or frangible region 12-a whose thickness is smaller than other portions of the flexible loop 12. The thinned region 12-a may be configured to break when subject to a tensile load of between 5-18 lbs. Alternatively, the flexible loop 12 may include a notched or scored portion 12-b (FIG. 3B) configured to break when subject to a tensile load of between 5-18 lbs.

In the embodiment depicted in FIG. 1 the flexible loop 12 is integrally formed with the housing 11.

In the embodiment depicted in FIGS. 1-3, the engagement system 20 includes a tapered head 22 having a shoulder 24 provided on the free end 14 and a pair of flanges 26 provided on the receptacle 18. In operation the tapered head 22 is inserted between the flanges 26 until shoulder 24 passes end 28 of the flange 26. The flanges 26 resist any attempt to withdraw the tapered head 22 from between the flanges 26. More particularly, the flexible loop 12 is designed to fail before the tapered head 22 may be withdrawn from between the flanges 26.

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims.

Various features of the invention are set forth in the appended claims.

1. A tamper-evident seal, comprising:
a main body;
a flexible loop having a free end and a fixed end, said fixed end being attached to said main body;
a receptacle provided in said main body and configured to at least partially receive said free end of said flexible loop;
non-releasable engagement means for retaining said free end within said receptacle;
wherein said flexible loop is configured to fail before the non-releasable engagement means releases said free end.

2. The tamper evident seal according to claim 1, wherein said flexible loop is composed of nylon.

3. The tamper evident seal according to claim 2 wherein said body and said non-releasable engagement means are composed of a non-metallic material.

4. The tamper evident seal according to claim 1, wherein said flexible loop is configured to fail when subjected to a tensile force of between 5 and 18 lbs.

5. The tamper evident seal according to claim 1 wherein said flexible loop further comprises a region of diminished thickness configure to fail before said non-releasable engagement means releases said free end.

6. The tamper evident seal according to claim 1 wherein said flexible loop includes a notched portion configure to fail before the non-releasable engagement means releases said free end.

7. The tamper evident seal according to claim 1, wherein said non-releasable engagement means comprises:
a tapered head provided on said free end, said tapered head having a shoulder; and
at least two flanges provided on said receptacle, said flanges provided in a spaced relationship to receive and retain said tapered head therebetween.
